(19) United States
(12) Patent Application Publication
(10) Pub. No.: US 2009/0236574 A1
(43) Pub. Date: Sep. 24, 2009

(54) Lawn mower and tractor lift

(76) Inventor: Douglas R. Smith, Fair Oak, CA (US)

Correspondence Address: MILDE & HOFFBERG, LLP, 10 BANK STREET, SUITE 460, WHITE PLAINS, NY, 10606, US

(21) Appl. No.: 12/321,896

(22) Filed: Jan. 27, 2009

Related U.S. Application Data
(60) Provisional application No. 61/062,592, filed on Jan. 28, 2008.

(51) Int. Cl. B66F 3/00

(52) U.S. Cl. 254/134

(57) ABSTRACT

A manually operated lifting device for adaptably lifting the front or back end of a lawn mower, garden tractor or similar small, powered vehicle, or to lift these vehicles from the side, is provided. The lifting device comprises a vertical frame having removable front arms at the bottom end and extending forward for engaging the axle of the mower or tractor, either at the front or back. The lifting device also comprises a horizontal arm at the bottom of the frame, for positioning and securing the vehicle while being lifted from the side, a collapsible base member and a threaded rod connect to the base member and the frame, such that turning the rod raises the frame from the base, thus lifting the vehicle. The rod may be turned using a hand crank or an electrical device such as an electric hand drill.

### CROSS REFERENCE TO RELATED APPLICATION

This application claims priority from U.S. provisional application No. 61/062,592 filed Jan. 28, 2008.

### BACKGROUND OF THE INVENTION

The present invention relates to a device that facilitates the servicing of non-commercial and commercial lawn mowers, tractors and similar light vehicles. More particularly, it relates to a device that lifts the front or back end of push lawn mowers and tilts riding mowers for access to the bottom of the units safely.

The blades of commercial lawn mowers require daily inspection and/or replacement. Moreover, commercial mowers, golf carts, and similar light vehicles need frequent lubrication and other maintenance procedures under the deck, as well. However, such vehicles are bulky and thus lifting them to facilitate blade changing or to perform lubrication or other maintenance procedures is cumbersome and difficult.

Also, the blades of push lawn mowers require inspection and/or replacement. Push lawn mowers need lubrication and other maintenance procedures such as changing oil or cleaning under the deck. However, for a person to undertake these process without a lifting device as described herein is not easy nor is it safe.

Many commercial lawn services use both push lawn mowers and riding mowers and require the ability to work on both types of mowers with out the purchase of type specific lifting equipment.

A hydraulic lift of the type used to elevate automobiles could be used, but such lifts are quite expensive to own, operate, and maintain. Moreover, it is not necessary to raise the entire mower or vehicle off the ground in order to perform routine maintenance procedure such as blade-changing; it is sufficient to merely lift the front end of the mower while leaving the rear wheels thereof in contact with a support surface. Similarly, lifting only the rearward axle of the vehicle facilitates lubrication and other maintenance procedures on the motor and drive train of riding mowers and tractors. Thus, use of a hydraulic lift that raises both the front and rear wheels off the ground represents an expensive and un-needed solution to the problems associated with blade changing, lubrication and other general maintenance.

However, since mowers, tractors, and the like, are mounted on wheels, they roll easily and thus defeat attempts to simply lift one end thereof without the mower wanting to roll away.

The lifting devise of the within invention could also include means for speeding the lift process by using available cordless or corded drills vs. the slower method of hand pumping a hydraulic jack. A manual lift or the ability to use a powered drill or ratchet to speed the lift process could be interchanged.

Thus, it would be advantageous if a device for lifting the front or rear end of a mower could be found that did not rely on hydraulic jacks. It would be even more advantageous if such a device could also provide a means for tilting larger riding mowers, tractors and the like, when performing routine maintenance procedures.

Accordingly, there arises a need for a device that can easily lift a push lawn mower, riding mower or tractor, from either the front or back end, or from the side. The device needs to be simple and easy to operate, and allow for adjustability in more than one application.

### OBJECTS OF THE INVENTION

It is therefore a principle object of the invention to provide an adjustable lifting device that can be used to safely lift push lawn mowers and riding mowers as well as similar light vehicles such as garden tractors, in order to perform maintenance on them.

It is also an object of the invention to provide a lifting device that is simple and easy to use for the average operator of a lawn mower or tractor.

It is a further object of the invention to provide a lifting device with the ability to be collapsed, carried, and stored easily.

It is another object of the invention to provide a lifting device that is a low cost alternative to expensive hydraulic lifts.

These and other objects of the invention will become more apparent in the description below.

### SUMMARY OF THE INVENTION

A principle object of the present invention is to provide a lifting device for lifting the front or back end of a lawn mower, garden tractor or similar small, powered vehicle, or to lift these vehicles from the side, in order to perform maintenance, that is adaptable to these purposes while being easy to use and simple to operate by the average person. Moreover, it is a principle object of this invention to provide a lifting device that is of relatively light weight, inexpensive, and collapsible for transporting and ease of storage.

In accordance with the invention, a manually operated lifting device for adaptably lifting the front or back end of a lawn mower, garden tractor or similar small, powered vehicle, or to lift these vehicles from the side, is provided. The lifting device comprises a vertical frame having removable front arms at the bottom end and extending forward for engaging the axle of the mower or tractor, either at the front or back.

The lifting device also comprises a horizontal arm at the bottom of the frame, for positioning and securing the vehicle while being lifted from the side. In this configuration, the lifting device includes a collapsible base element and a threaded rod connect to the base element and the frame, such that turning the rod raises the frame from the base, thus lifting the vehicle. The rod may be turned using a hand crank or an electrical device such as an electric hand drill.

Thus, the present invention provides a lifting device for lifting the front or back end of a lawn mower, garden tractor or similar small, powered vehicle, or to lift these vehicles from the side, in order to perform maintenance, that is adaptable to these purposes and is easy to use.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is an exploded view of a lifting device in accordance with an embodiment of the present invention;

FIG. 2 is an assembled view of a lifting device in accordance with an embodiment of the present invention;

FIG. 3 is a perspective view of a preferred embodiment of the present invention, illustrating lifting a vehicle from the side;

FIG. 4A is a perspective view of an assembled preferred embodiment of the present invention, illustrating operation prior to lifting the front end of a vehicle; and

FIG. 4B is a perspective view of an assembled preferred embodiment of the present invention, illustrating operation after lifting the front end of a vehicle.

### DETAILED DESCRIPTION OF THE PREFERRED EMBODIMENTS

The invention was previously described in provisional application Ser. No. 61/062,592, filed Jan. 28, 2008. The disclosure thereof is hereby incorporated by reference.

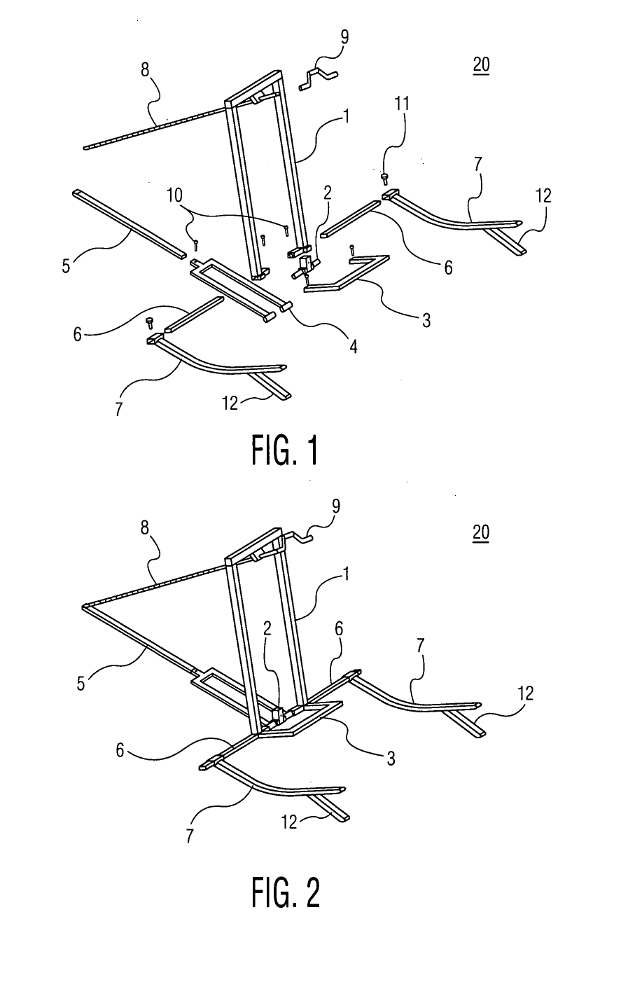

The preferred embodiments of the present invention will now be described with reference to FIGS. 1-4 of the drawings. Identical elements in the various figures are designated with the same reference numerals. The various embodiments of the invention described below are preferably made from aluminum, iron or steel, or other substantially strong metal or material.

An adaptable lifting device 20 having features for lifting the front or back end of a lawn mower, garden tractor or similar small, powered vehicle, or to lift these vehicles from the side, is described. It will be understood how other lifting devices having vertical frame members and horizontal attachment arms may embody the principles and features of this invention.

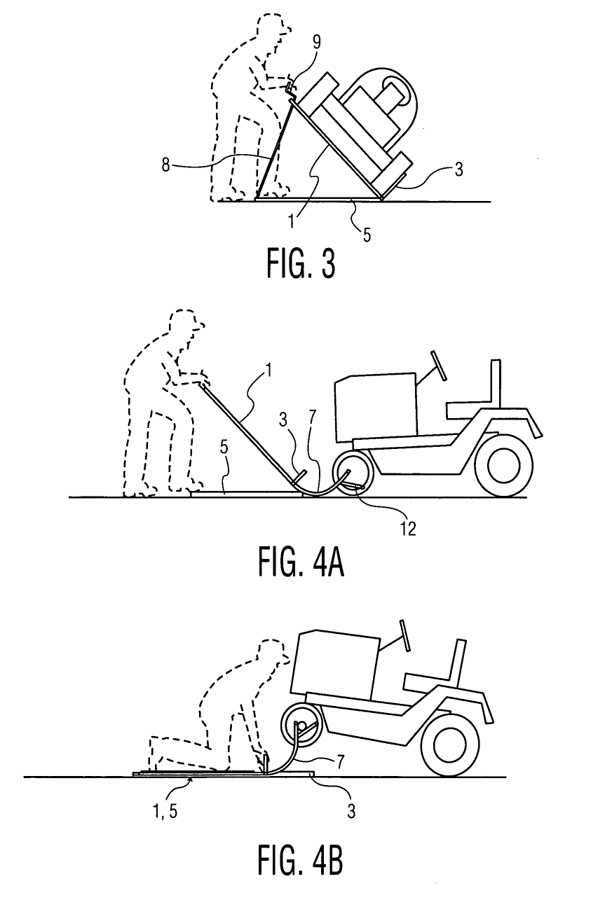

With reference to the drawings and in particular FIGS. 1-4 initially, which illustrate a preferred embodiment of a lifting device according to the invention, generally designated by the reference number 20. FIG. 1 provides an exploded view of the lifting device 20 which is comprised of various parts which are collectively shown in FIGS. 1 and 2. Lifting device 20 includes a vertical frame 1 formed of aluminum, iron or steel. Vertical frame 1 can be in any shape, with round or rectangular shapes being preferred. At the lower end of the vertical frame 1 other members of the lifting device are attached. Specifically, horizontal arm 3 is attached at the bottom end of frame 1, such that it extends outward at a 90° angle from frame 1. Arm 3 is fixedly attached to frame 1 such that it can be placed under the vehicle to be lifted and to also bear the weight of the vehicle. Arm 3 can be placed either under the front or back of a vehicle, or can hold the vehicle on its side as seen in FIG. 3.

Front arms 7 are also removably attached at the bottom end of frame 1 at the sides thereof, being spaced apart from frame 1 by means of spacers 6, which can be of any desired length. Front arms 7 are removably attached to spacers 6 by screws 11. When front arms 7 are attached to frame 1, they are fixed such that they may bear the weight of the vehicle being lifted, which is typically the front or back end of a mower or tractor. Front arms 7 also include a hook member 12 located near the ends of each front arm 7, forming the shape of the letter “V.” The ends of front arms 7 are then placed under the axle of the vehicle, where it can be secured by means of a strap or similar device, where front arms 7 and hooks 12 form a cradle for the axle as the front arms 7 are rotated from a horizontal to a vertical position, as shown in FIGS. 4A and 4B. Front arms 7 are arcuate in design, which facilitates the lifting of the front or back of a vehicle by placing force in a direction away from the vehicle, as also shown in FIGS. 4A and 4B. When in the lifted position (FIG. 4B) arm 3 can be used as a safety extension to lock the lifting device in the lifted position.

Also shown in FIGS. 1 and 4 is one embodiment of a lifting device 20 further including elements for lifting a vehicle from the side. Specifically, a base member 5 is pivotally attached at the bottom of frame 1, using a pivotal element 2 connected to sleeves 4 at the end of base member 5, in a direction opposite to that of arm 3. Base member 5 typically has a length at least equal to the height of frame 1. One end of a threaded rod 8 is rotatably attached at the end of base member 5, with the other end of rod 8 rotatably attached at the upper end of frame 1. A hand crank 9 is attached at the upper end of rod 8 such that rotation of rod 8 by hand crank 9 causes frame 1 to move away from base member 5, much in the manner of a common automobile jack that has a similar threaded rod.

The operation of the lifting device to lift from the side of a vehicle is shown in FIG. 3. In this application, front arms 7 are removed, and base member 5 is collapsed to be in the same plane as frame 1. Then, nearly the entire lifting device 20 is placed under the front or back wheels of the vehicle, from the side, such that arm 3 contacts the outer side of the opposite wheel, where it can be secured by a strap or other means. Once in position, hand crank 9 is turned which elevates frame 1 from base member 5, which now forms a base of the lifting device 20 on the ground. Hand crank 9 is turned until the desired height of frame 1 is achieved, where it will remain secured until the crank is turned in the opposite direction to lower frame 1. Alternatively, an electrical device can be used to turn rod 8, such as an electrical drill.

The operation of the lifting device from the front or back of the vehicle is illustrated in FIGS. 4A and 4B. There, front arms 7 with hooks 12 are placed under the vehicle to engage the axle. Applying horizontal pressure away from the vehicle on the upper end of frame 1 causes the device to rock backwards on arcuate arms 7, causing arms 7 to rise to a vertical position where, the axle is lifted by the arms 7.

The preceding preferred embodiments are illustrative of the practice of the invention. It is to be understood, however, that other expedients known to those of skill in the art, or disclosed herein, may be employed without departing from the spirit of the invention or the scope of the claims.

What is claimed is:

1. A device for lifting and end or side of a lawn mower, tractor or similar vehicle, comprising:
an elongated frame member, having an upper and a lower end;
a base member, having an upper end and a lower end, the lower end of the base member being pivotally attached at the lower end of the elongated frame member and wherein said base member is pivotally collapsible to the same plane as the elongated frame member;
a threaded rod rotatably connected at one end to the upper end of the base member, and the opposite end of the threaded rod rotatably connected to the upper end of the frame;
means for rotating the threaded rod,
a horizontal arm extending outwardly from the lower end of the frame;
wherein, rotation of the threaded rod causes the frame to pivotally separate from the plane of the base member.

2. The device of claim 1, further comprising arcuate front arms extending from the sides of the lower end of the frame, wherein the front arms are configured to engage an axle of a vehicle.

3. The device of claim 1, wherein said horizontal arm is pivotally attached at the lower end of the frame.

4. The device of claim 2, wherein the front arms further comprise a hook for engaging the axle of the vehicle, wherein the hook and the front arm together form a cradle for the axle when in a lifted position.

5. The device of claim 1, wherein the means for rotating the threaded rod comprises a hand crank.

6. The device of claim 1, wherein the front arms are separated from the sides of the frame by means of spacers.

7. The device of claim 1, wherein the means for rotating the threaded rod comprises an electric drill.

8. The device of claim 2, wherein said front arms are removable.
